(19) United States
(12) Patent Application Publication
(10) Pub. No.: US 2025/0086370 A1
(43) Pub. Date: Mar. 13, 2025

(54) METHODS AND APPARATUS FOR CROSSTALK-BASED CLOSED-FORM EXPRESSION FOR IMPROVED PRINTED CIRCUIT BOARD (PCB) DESIGNS

(71) Applicant: Intel Corporation, Santa Clara, CA (US)

(72) Inventors: Kuan-Yu Chen, Portland, OR (US); Michael Wilmer Leddige, Middleton, ID (US); Diego Mauricio Cortes Hernandez, Hillsboro, OR (US); John Sharpe, Happy Valley, OR (US)

(73) Assignee: Intel Corporation, Santa Clara, CA (US)

(21) Appl. No.: 18/958,896

(22) Filed: Nov. 25, 2024

(51) Int. Cl. G06F 30/392; G06F 30/27; G06F 30/3947; G06F 115/12; G06F 119/10

(52) U.S. Cl. CPC G06F 30/392; G06F 30/27; G06F 30/3947; G06F 2115/12; G06F 2119/10

(57) ABSTRACT

An example apparatus includes interface circuitry, machine-readable instructions, and at least one processor circuit to be programmed by the machine-readable instructions to identify crosstalk between a first signal via and a second signal via on a printed circuit board (PCB) layout, determine an area for placement of a ground via between the first signal via and the second signal via, and classify one or more regions of the PCB layout into at least one of a protective area or a non-protective area based on the area for placement of the ground via.

### BACKGROUND

Printed circuit boards (PCBs) include a layer stack-up built with alternating layers of conductive and insulating materials. While conventional PCBs form traces and vias using subtractive etching methods, more advanced PCB systems operating at the highest data rates use metal deposition processes for board production. Circuit board design processes include front-end engineering, schematic capture, material selection and stack-up design, component placement, and routing of traces between the components.

### BRIEF DESCRIPTION OF THE DRAWINGS

FIG. 1 is a block diagram of an example implementation of printed circuit board (PCB) layout optimizer circuitry constructed in accordance with teachings of this disclosure to determine positioning of a ground via relative to other signal vias.

FIG. 2 is a flowchart representative of example machine-readable instructions and/or example operations that may be executed, instantiated, and/or performed by example programmable circuitry to implement the example PCB layout optimizer circuitry of FIG. 1.

FIG. 3 is a flowchart representative of example machine-readable instructions and/or example operations that may be executed, instantiated, and/or performed by example programmable circuitry to implement a computing system of FIG. 1 to train a layout model.

FIG. 4 is a flowchart representative of example machine-readable instructions and/or example operations that may be executed, instantiated, and/or performed by example programmable circuitry to implement the example PCB layout optimizer circuitry of FIG. 2 to determine allowed area(s) for ground via placement in the input PCB layout.

FIG. 5 illustrates example positioning of a first signal via (e.g., a victim via) relative to a second signal via (e.g., an aggressor via).

FIG. 6 illustrates an example printed circuit board (PCB) stack-up used in a three-dimensional simulation that includes an example signal via structure.

FIG. 7A illustrates example positioning of a ground via relative to the first signal via (e.g., the victim via) and the second signal via (e.g., the aggressor via).

FIG. 7B illustrates example positioning of the ground via at a specified angle relative to the victim via and/or the aggressor via.

FIG. 8A illustrates an example first curve corresponding to parametric variation of ground via placement (e.g., without an angle sweep) for a through hole via.

FIG. 8B illustrates an example second curve corresponding to parametric variation of ground via placement (e.g., with an angle sweep) for a through hole via.

FIG. 9A illustrates example allowed and disallowed areas for ground via placement relative to the victim via and/or the aggressor via.

FIG. 9B illustrates an example table of angle variation associated with ground via placement and corresponding horizontal distance of the ground via relative to the victim via, as shown in connection with FIG. 9A.

FIG. 10 illustrates example positioning of a ground via between a victim via and an aggressor via, with a rhombus representing a zone for ground via positioning based on crosstalk (e.g., near-end crosstalk and/or far-end crosstalk).

FIG. 11A illustrates a first example of a rule violation association with ground via placement outside the rhombus zone of FIG. 10.

FIG. 11B illustrates a second example of a rule violation associated with ground via placement outside the rhombus zone of FIG. 10.

FIG. 11C illustrates a first example of a ground via placement that satisfies signal integrity (SI) guidelines based on positioning within the rhombus zone of FIG. 10.

FIG. 11D illustrates a second example of a ground via placement that satisfies signal integrity (SI) guidelines based on positioning within the rhombus zone of FIG. 10.

FIG. 12 is a block diagram of an example processing platform including programmable circuitry structured to execute, instantiate, and/or perform the example machine readable instructions and/or perform the example operations of FIGS. 2 and/or 4 to implement the PCB layout optimizer circuitry of FIG. 1.

FIG. 13 is a block diagram of an example processing platform including programmable circuitry structured to execute, instantiate, and/or perform the example machine readable instructions and/or perform the example operations of FIG. 3 to implement the computing system of FIG. 1.

FIG. 14 is a block diagram of an example implementation of the processor circuitry of FIGS. 12 and/or 13.

FIG. 15 is a block diagram of another example implementation of the programmable circuitry of FIGS. 12 and/or 13.

FIG. 16 is a block diagram of an example software/firmware/instructions distribution platform (e.g., one or more servers) to distribute software, instructions, and/or firmware (e.g., corresponding to the example machine readable instructions of FIGS. 2-4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

As interconnect signaling speed and bandwidth have increased to keep pace with Moore's Law, received signal amplitudes have correspondingly decreased. Coupled with the move from binary signaling towards Pulse Amplitude Modulation (PAM), there is a continued reduction of available received signal strength. As such, allowable noise tolerances are set even lower to ensure a robust interconnect that can achieve a low bit-error rate (BER). Additionally, the number of high-speed Input/Output (HSIO) ports on processors has continued to increase, driving up the density of traces in printed circuit boards (PCBs) and packages. Control of crosstalk between signals, which results in an undesired electromagnetic (EM) coupling between nearby signals, is taking on a greater role in physical designs and represents an ongoing challenge.

Spacing is crucial to avoid crosstalk, electromagnetic interference (EMI), and other signal integrity issues. PCB and package designers rely on conservative spacing rules to ensure signal integrity margins. However, such rules often lead to greater than necessary spacings, resulting in an increased routing area and layers that drive up costs. Furthermore, traditional conservative spacing rules may not fully realize the potential benefits of ground vias acting as shielding, and a reduced spacing requirement would represent a cost benefit in PCB designs.

Known solutions for PCB layout and design include layout check tools and simulation methods. Layout check tools include commercial tools available for PCB layout analysis and layout improvement, but few such tools specifically address the improvement of spacing around ground vias or traces acting as shielding. Existing tools often focus on general design rule checking (DRC) or signal integrity analysis but may not offer the level of granularity required to improve spacing in specific areas. Three-dimensional simulation tools (e.g., Ansys Electronic Desktop, PathWave EM Design, etc.) can be used to perform an extraction of the PCB layout structure, which is useful for obtaining accurate results to make decisions from a design perspective based on signal integrity results. However, extracting these structures is time consuming and requires significant computational resources. For example, extracting all structures is risky from a design point of view because milestones and PCB layout versions tend to change often during the design of an integrated circuit package (e.g., a server). While indispensable early in the design process, simulation tools are impractical to use for final design checks due to speed and processing-based issues.

Additional known solutions include PCB stack-up modification and electrical validation. PCB manufacturers offer solutions to modify the stack-up using several alternatives, including increasing the layer number, adding multiple vias, including more back drill levels, or applying microvia technology. For example, increasing spacing between structures in the layout reduces the impact of crosstalk. However, adding layer counts adds to the cost of the board, given that back drilling is expensive as a post processing requirement and is limited in range (e.g., due to registration areas and/or microvia buildup layers that come at a cost of three to five times over standard PCB layer counts). Furthermore, additional solutions focus on risk-controlled strategies combined with the use of firmware to reduce signal degradation. Although such methods identify low risk/high risk scenarios and can be used to validate simulation results, such an approach introduces an additional expense, while any issues may only be identified late in the product design cycle.

Methods and apparatus disclosed herein improve package and PCB designs by applying a closed-form algorithm based on three-dimensional electromagnetic modeling that improves the distance between two signal vias (e.g., victim and aggressor vias) and defines an area of location for a ground via to achieve a desired level of shielding. In examples disclosed herein, a machine learning model can be applied to assess the PCB layout and provide flexibility to designers by identifying an area to position a shield via for low crosstalk (e.g., fit a rhombus-type shape to satisfy the solution space as compared to relying on restrictive line-of-sight (LOS) distance rules). Methods and apparatus disclosed herein can be incorporated into machine-readable tools for use in artificial intelligence (AI)-based engines for further integration into auto-routing computer-aided design (CAD) packages. In examples disclosed herein, the proposed algorithm can be customized for different package and/or PCB stack-ups (e.g., layer thicknesses) and scaled to the allowable level of crosstalk that the Input/Output ports can tolerate. Such an algorithm allows for machine checkable rules which can be run quickly on design layers to ensure compliance to applicable rules implemented during final board design reviews. For example, designers are provided with a solution space instead of having to adhere to a specific distance (e.g., between the vias, etc.), such that traces can be moved around on other layers while achieving the required shielding.

In example methods and apparatus disclosed herein, various parameters can be identified relating to trace routing, signal via locations, trace locations, component locations, and/or other design elements. For example, training data can be generated based on the layout features for use in identifying regions that should be designated as protective areas (e.g., areas suitable for ground via placement for shielding against crosstalk) and non-protective areas (e.g., areas not suitable for ground via placement). In examples disclosed herein, the trained machine learning model can be used to predict improved shielding areas (e.g., areas protected from electromagnetic interference where ground vias can be placed) in new PCB designs. In some examples, optimization techniques can be applied to adjust routing and/or trace placement(s) based on identified shielding areas and/or optimizing factors (e.g., space reduction, etc.). In examples disclosed herein, placement for ground vias determined using the machine learning model results in a low crosstalk environment that ensures PCB design quality. Similarly, methods and apparatus disclosed herein can be used to avoid the expense of simulation tools and/or iteration of test builds during the design cycle. By carefully analyzing and reducing the spacing around critical PCB elements, board designers can mitigate crosstalk, reduce electromagnetic interference, and/or improve signal integrity. For example, reducing the space between traces and vias reduces (e.g., minimizes) electromagnetic coupling, reducing crosstalk. Reduced crosstalk is crucial to maintaining signal integrity and avoiding unwanted interference, especially in high-frequency designs. Reducing crosstalk on high-speed channels also prevents re-spins or functional risks after manufacturing, resulting in cost savings from a design perspective.

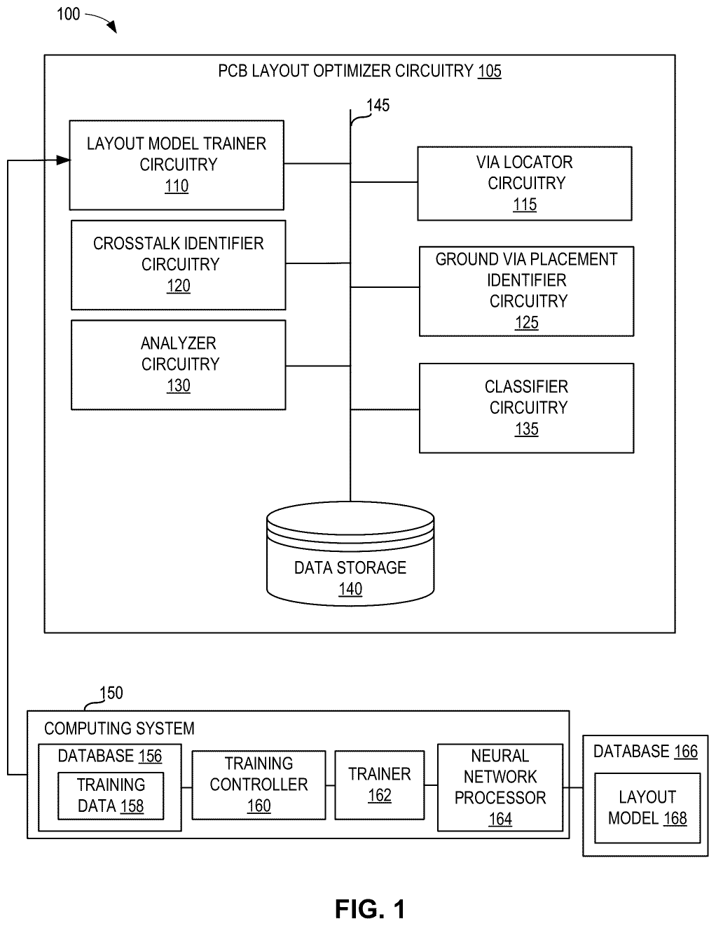

FIG. 1 is a block diagram 100 illustrating an example implementation of PCB layout optimizer circuitry 105 to improve PCB-based designs associated with via positioning. The PCB layout optimizer circuitry 105 of FIG. 1 may be instantiated (e.g., creating an instance of, bring into being for any length of time, materialize, implement, etc.) by programmable circuitry such as a Central Processing Unit (CPU) executing first instructions. Additionally or alternatively, the PCB layout optimizer circuitry 105 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

In the example of FIG. 1, the PCB layout optimizer circuitry 105 includes example layout model trainer circuitry 110, example via locator circuitry 115, example crosstalk identifier circuitry 120, example ground via placement identifier circuitry 125, example analyzer circuitry 130, example classifier circuitry 135, and example data storage 140. In the example FIG. 1, the layout model trainer circuitry 110, via locator circuitry 115, crosstalk identifier circuitry 120, ground via placement identifier circuitry 125, analyzer circuitry 130, classifier circuitry 135, and data storage 140 are in communication using an example bus 145.

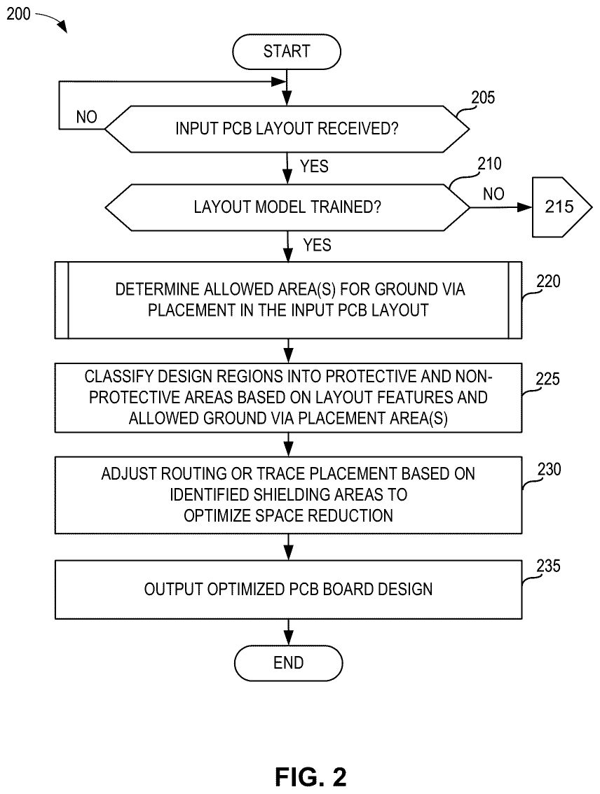

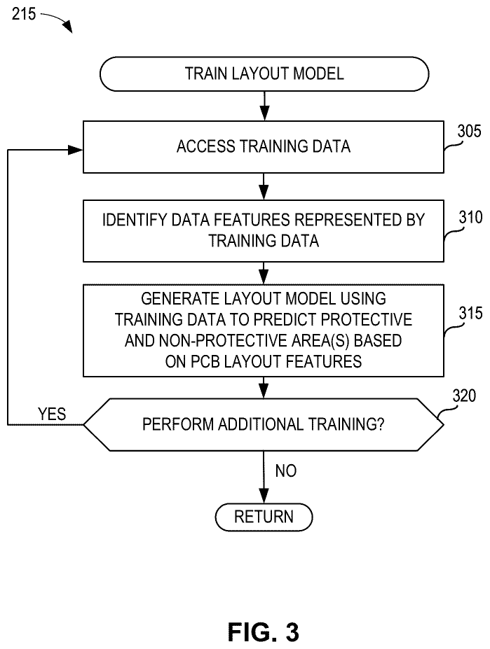

The layout model trainer circuitry 110 performs training of a layout model. For example, training of the layout model allows for the identification of a preferred PCB design (e.g., positioning of vias, traces, etc.) based on a received input PCB layout. In examples disclosed herein, the layout model trainer circuitry 110 generates training data to train a layout model to classify the one or more regions of the PCB layout. In some examples, the layout model trainer circuitry 110 is instantiated by programmable circuitry executing layout model trainer instructions and/or configured to perform operations such as those represented by the flowchart(s) of FIGS. 2-3. As illustrated in FIG. 1, the layout model trainer circuitry 110 is in communication with a computing system 150 that trains a neural network to generate an example layout model 168. In examples disclosed herein, any training algorithm may be used. In examples disclosed herein, training can be performed based on early stopping principles in which training continues until the model stops improving. In examples disclosed herein, training can be performed remotely or locally. Further training (e.g., retraining) may be performed locally based on data generated as a result of execution of the models. Training is performed using hyperparameters that control how the learning is performed (e.g., a learning rate, a number of layers to be used in the machine learning model, etc.). In examples disclosed herein, hyperparameters that control complexity of the model(s), performance, duration, and/or training procedure(s) can be used. Such hyperparameters are selected by, for example, random searching and/or prior knowledge. In some examples, re-training may be performed. Such re-training may be performed in response to new input datasets, drift in the model performance, and/or updates to model criteria and system specifications.

Training is performed using training data. In examples disclosed herein, the training data allows for an identification of a domain (e.g., a source domain or a target domain) associated with the input data (e.g., input PCB layout(s)). In some examples, the training data is labeled. In some examples, the training data is sub-divided such that a portion of the data is used for validation purposes.

Once training is complete, the layout model 168 is stored in one or more databases (e.g., database 156, 166 of FIG. 1). One or more of the models may then be executed by, for example, the layout model trainer circuitry 110. Once trained, the deployed model(s) may be operated in an inference phase to process data. In the inference phase, data to be analyzed (e.g., live data) is input to the model, and the model executes to create an output. This inference phase can be thought of as the artificial intelligence (AI) “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model(s) may be captured and provided as feedback. By analyzing the feedback, an accuracy of the deployed model(s) can be determined. If the feedback indicates that the accuracy of the deployed model(s) is less than a threshold or other criterion, training of an updated model can be triggered using the feedback and an updated training data set, hyperparameters, etc., to generate an updated, deployed model(s).

As shown in FIG. 1, the computing system 150 trains a neural network to generate the layout model 168. The example computing system 150 includes a neural network processor 164. In examples disclosed herein, the neural network processor 164 implements a neural network. The computing system 150 of FIG. 1 also includes a neural network trainer 162 (e.g., trainer circuitry). The neural network trainer 162 of FIG. 1 performs training of the neural network implemented by the neural network processor 164 (e.g., neural network processor circuitry).

The computing system 150 of FIG. 1 includes a training controller 160 (e.g., training controller circuitry). The training controller 160 instructs the neural network trainer 162 to perform training of the neural network based on training data 158. In the example of FIG. 1, the training data 158 used by the neural network trainer 162 to train the neural network is stored in a database 156. The example database 156 of the illustrated example of FIG. 1 is implemented by any memory, storage device and/or storage disc for storing data such as, for example, flash memory, magnetic media, optical media, etc. Furthermore, the data stored in the example database 156 may be in any data format such as, for example, binary data, comma delimited data, tab delimited data, structured query language (SQL) structures, image data, etc. While the illustrated example database 156 is illustrated as a single element, the database 156 and/or any other data storage elements described herein may be implemented by any number and/or type(s) of memories. The neural network trainer 162 trains the neural network implemented by the neural network processor 164 using the training data 158 to generate the layout model 168 as a result of the neural network training. The layout model 168 is stored in a database 166. The databases 156, 166 may be the same storage device or different storage devices.

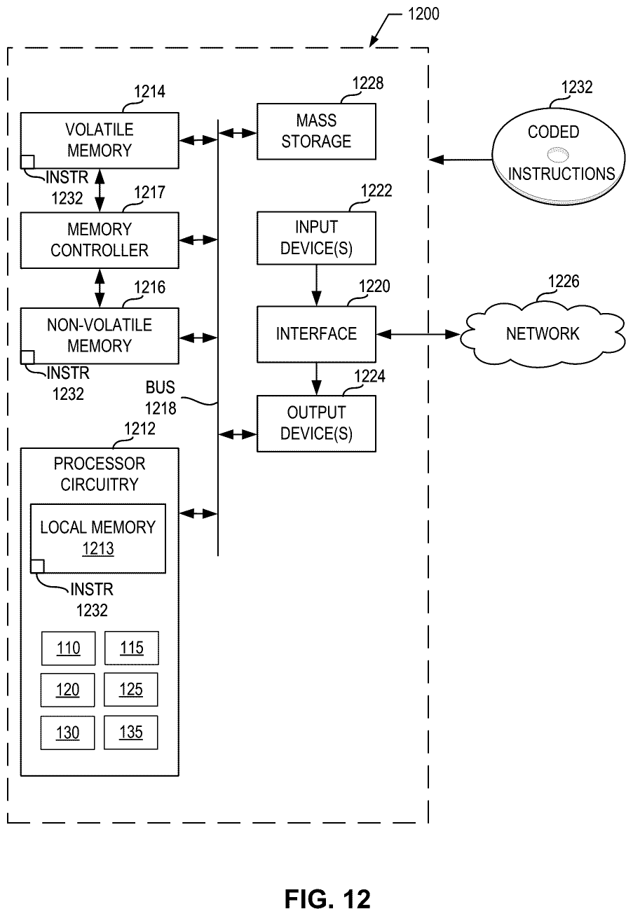

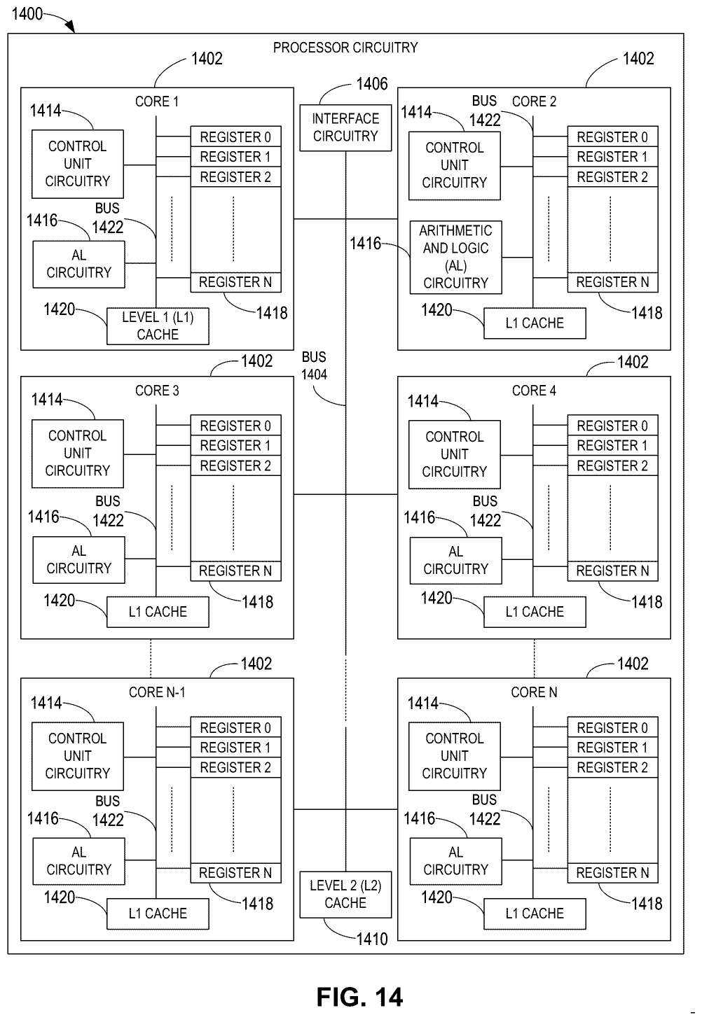

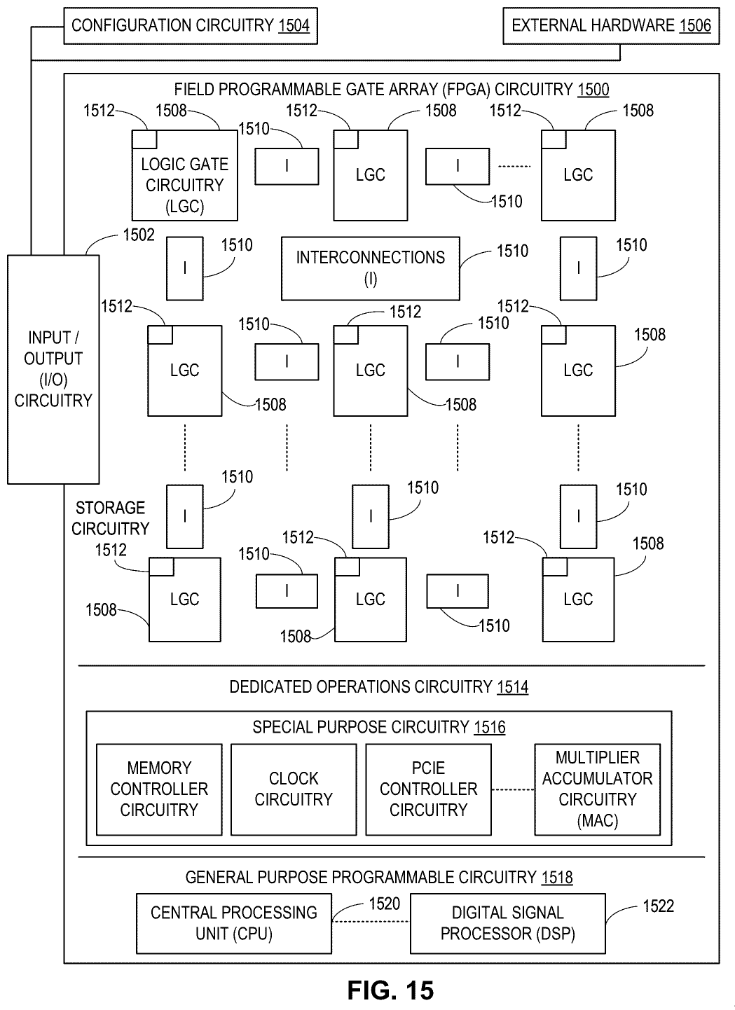

In some examples, the apparatus includes means for training a layout model. For example, the means for training a layout model may be implemented by layout model trainer circuitry 110. In some examples, the layout model trainer circuitry 110 may be instantiated by programmable circuitry such as the example programmable circuitry 1212 of FIG. 12. For instance, the layout model trainer circuitry 110 may be instantiated by the example microprocessor 1400 of FIG. 14 executing machine executable instructions such as those implemented by at least block(s) 305, 310, 315, 320 of FIG. 3. In some examples, the layout model trainer circuitry 110 may be instantiated by hardware logic circuitry, which may be implemented by an ASIC, XPU, or the FPGA circuitry 1500 of FIG. 15 structured to perform operations corresponding to the machine readable instructions. Additionally or alternatively, the layout model trainer circuitry 110 may be instantiated by any other combination of hardware, software, and/or firmware. For example, the layout model trainer circuitry 110 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The via locator circuitry 115 identifies via(s) on the input PCB layout. For example, the via locator circuitry 115 identifies the victim via(s) and/or the aggressor via(s). In some examples, the via locator circuitry 115 identifies the positioning of a first signal via (e.g., the victim via) relative to a second signal via (e.g., the aggressor via). For example, the via locator circuitry 115 identifies any type of via structure on the PCB layout (e.g., hole vias, blind vias, stacked vias, staggered vias, microvias, etc.). In some examples, the via locator circuitry 115 is instantiated by programmable circuitry executing via locator instructions and/or configured to perform operations such as those represented by the flowchart(s) of FIGS. 2 and/or 4.

In some examples, the apparatus includes means for locating a via. For example, the means for locating a via may be implemented by via locator circuitry 115. In some examples, the via locator circuitry 115 may be instantiated by programmable circuitry such as the example programmable circuitry 1212 of FIG. 12. For instance, the via locator circuitry 115 may be instantiated by the example microprocessor 1400 of FIG. 14 executing machine executable instructions such as those implemented by at least block 220 of FIG. 2. In some examples, the via locator circuitry 115 may be instantiated by hardware logic circuitry, which may be implemented by an ASIC, XPU, or the FPGA circuitry 1500 of FIG. 15 structured to perform operations corresponding to the machine readable instructions. Additionally or alternatively, the via locator circuitry 115 may be instantiated by any other combination of hardware, software, and/or firmware. For example, the via locator circuitry 115 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

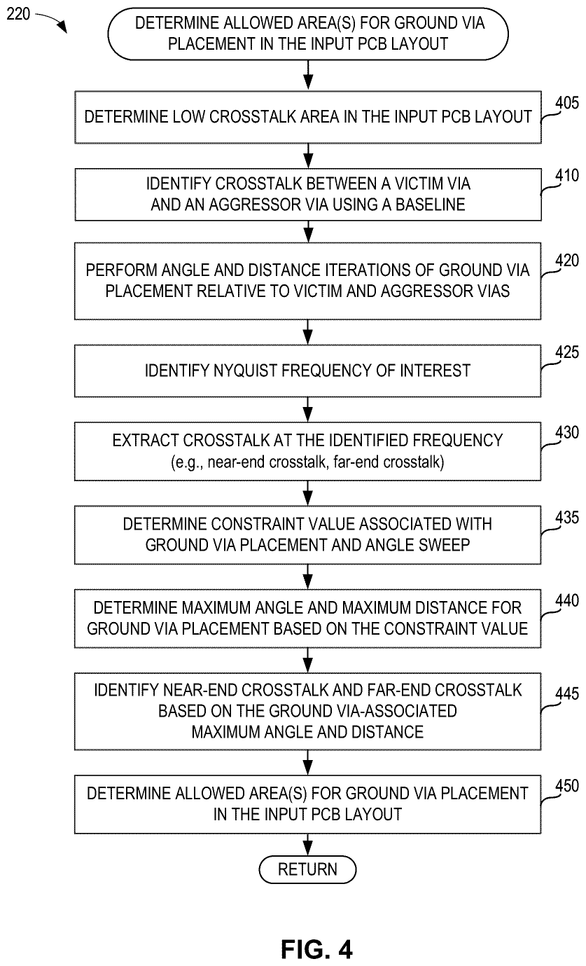

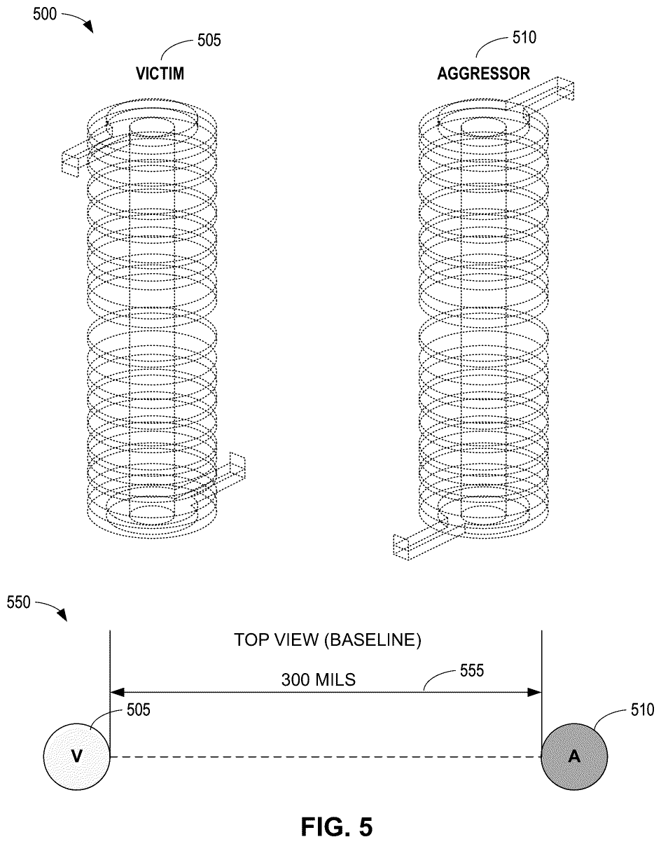

The crosstalk identifier circuitry 120 identifies crosstalk by analyzing the spacing around critical PCB elements. For example, the crosstalk identifier circuitry 120 identifies crosstalk between vias (e.g., resulting in unwanted coupling between aggressor signals and victim signals). In some examples, the crosstalk identifier circuitry 120 identifies crosstalk sources such as connectors, cables, alternating circuit (AC) coupling capacitors, PCB traces, and/or other vias. The crosstalk identifier circuitry 120 identifies crosstalk as a function of the relative signal strength of the aggressor signal as compared to the victim signal at the region of coupling. In some examples, the crosstalk identifier circuitry 120 identifies channel crosstalk based on a signal to power sum crosstalk ratio (e.g., using Nyquist frequency measurements), as described in more detail in connection with FIGS. 4-5. For example, the crosstalk identifier circuitry 120 determines low crosstalk area(s) in the input PCB layout and identifies near-end crosstalk and/or far-end crosstalk, as described in more detail in connection with FIG. 4. While near-end crosstalk propagates in a direction opposite the direction of the aggressor signal, far-end crosstalk propagates in the same direction as the aggressor signal. In some examples, the crosstalk identifier circuitry 120 is instantiated by programmable circuitry executing crosstalk identifier instructions and/or configured to perform operations such as those represented by the flowchart(s) of FIG. 4.

In some examples, the apparatus includes means for identifying crosstalk. For example, the means for identifying crosstalk may be implemented by crosstalk identifier circuitry 120. In some examples, the crosstalk identifier circuitry 120 may be instantiated by programmable circuitry such as the example programmable circuitry 1212 of FIG. 12. For instance, the crosstalk identifier circuitry 120 may be instantiated by the example microprocessor 1400 of FIG. 14 executing machine executable instructions such as those implemented by at least block(s) 405, 410, 445 of FIG. 4. In some examples, the crosstalk identifier circuitry 120 may be instantiated by hardware logic circuitry, which may be implemented by an ASIC, XPU, or the FPGA circuitry 1500 of FIG. 15 structured to perform operations corresponding to the machine readable instructions. Additionally or alternatively, the crosstalk identifier circuitry 120 may be instantiated by any other combination of hardware, software, and/or firmware. For example, the crosstalk identifier circuitry 120 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

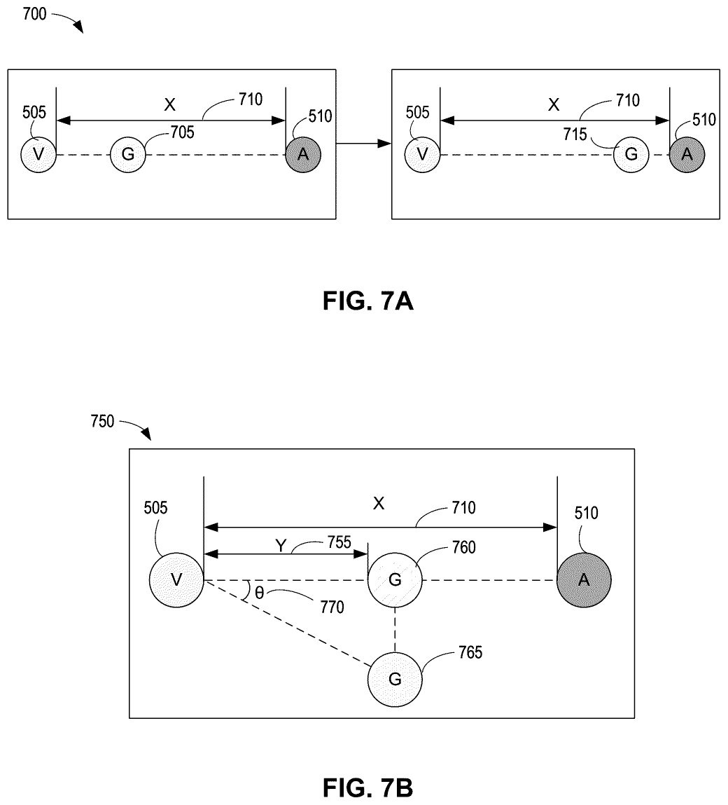

The ground via placement identifier circuitry 125 identifies placement of the ground vias based on the layout model trained using the layout model trainer circuitry 110. For example, based on an input PCB layout, the ground via placement identifier circuitry 125 determines allowed area(s) for ground via placement. In some examples, the ground via placement identifier circuitry 125 identifies the ground via placement based on identified crosstalk values, protective and/or non-protective areas of the PCB layout, and/or identified shielding areas used for optimizing space reduction. In some examples, the ground via placement identifier circuitry 125 identifies placement of a ground via at a specified angle relative to the victim via and/or the aggressor via, as described in connection with FIGS. 7A-7B. In some examples, the ground via placement identifier circuitry 125 is instantiated by programmable circuitry executing ground via placement identifier instructions and/or configured to perform operations such as those represented by the flowchart(s) of FIGS. 2 and/or 4.

In some examples, the apparatus includes means for identifying ground via placement. For example, the means for identifying ground via placement may be implemented by the ground via placement identifier circuitry 125. In some examples, the ground via placement identifier circuitry 125 may be instantiated by programmable circuitry such as the example programmable circuitry 1212 of FIG. 12. For instance, the ground via placement identifier circuitry 125 may be instantiated by the example microprocessor 1400 of FIG. 14 executing machine executable instructions such as those implemented by at least block 450 of FIG. 4. In some examples, the ground via placement identifier circuitry 125 may be instantiated by hardware logic circuitry, which may be implemented by an ASIC, XPU, or the FPGA circuitry 1500 of FIG. 15 structured to perform operations corresponding to the machine readable instructions. Additionally or alternatively, the ground via placement identifier circuitry 125 may be instantiated by any other combination of hardware, software, and/or firmware. For example, the ground via placement identifier circuitry 125 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

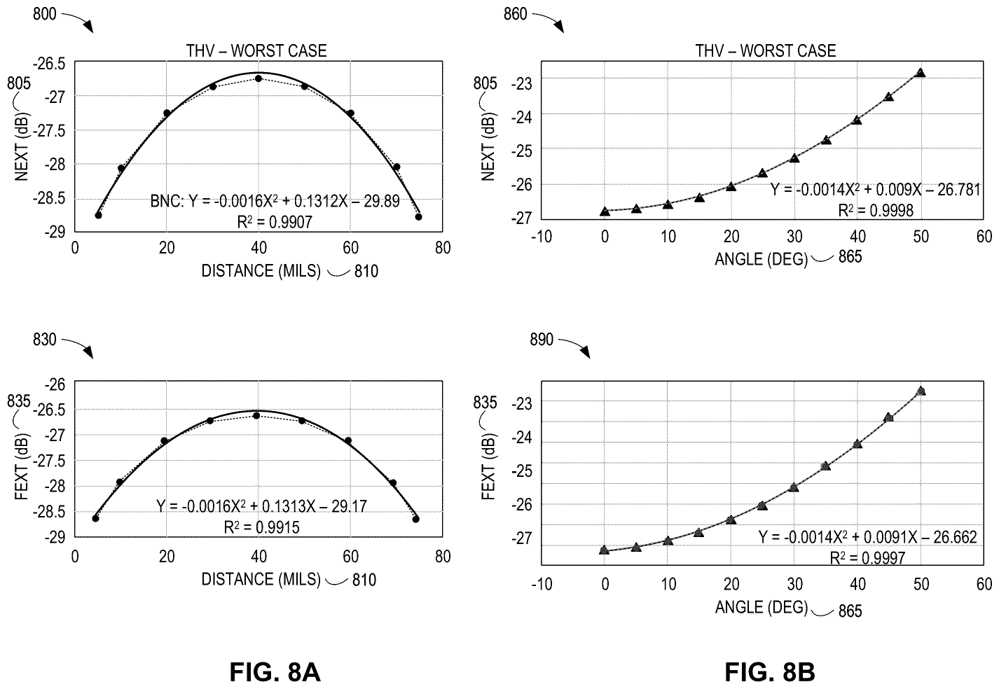

The analyzer circuitry 130 performs analysis associated with identifying allowed areas for ground via placement in the input PCB layout. For example, the analyzer circuitry 130 performs angle and distance iterations of ground via placement relative to the victim and/or aggressor vias. In some examples, the analyzer circuitry 130 determines constraint values associated with ground via placement and the identified angle sweep, as described in more detail in connection with FIG. 4. For example, the analyzer circuitry 130 identifies a maximum angle and a maximum distance for ground via placement based on the constraint value. In some examples, the analyzer circuitry 130 performs a parametric simulation (e.g., using electromagnetic simulation software such as Ansys HFSS, EMWorks, etc.) with the ground via being systematically positioned between the victim via and the aggressor via at different positions to identify crosstalk changes based on the ground via position(s), as described in connection with FIGS. 8A-8B. For example, the analyzer circuitry 130 identifies a maximum angle and/or a maximum distance between the victim via and the aggressor via based on ground via positioning. In some examples, the analyzer circuitry 130 is instantiated by programmable circuitry executing analyzer instructions and/or configured to perform operations such as those represented by the flowchart(s) of FIGS. 2 and/or 4.

In some examples, the apparatus includes means for performing analyses. For example, the means for performing analyses may be implemented by the analyzer circuitry 130. In some examples, the analyzer circuitry 130 may be instantiated by programmable circuitry such as the example programmable circuitry 1212 of FIG. 12. For instance, the analyzer circuitry 130 may be instantiated by the example microprocessor 1400 of FIG. 14 executing machine executable instructions such as those implemented by at least block(s) 420, 435, 440 of FIG. 4. In some examples, the analyzer circuitry 130 may be instantiated by hardware logic circuitry, which may be implemented by an ASIC, XPU, or the FPGA circuitry 1500 of FIG. 15 structured to perform operations corresponding to the machine readable instructions. Additionally or alternatively, the analyzer circuitry 130 may be instantiated by any other combination of hardware, software, and/or firmware. For example, the analyzer circuitry 130 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

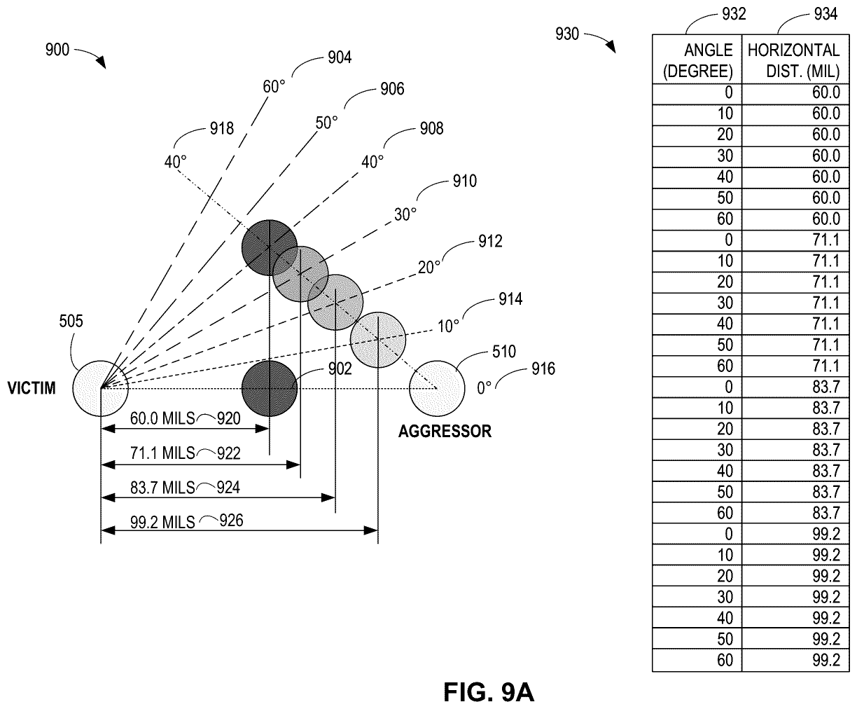

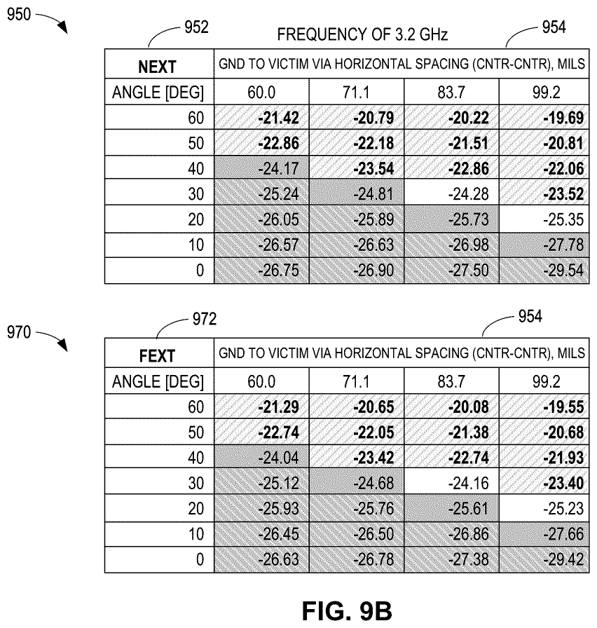

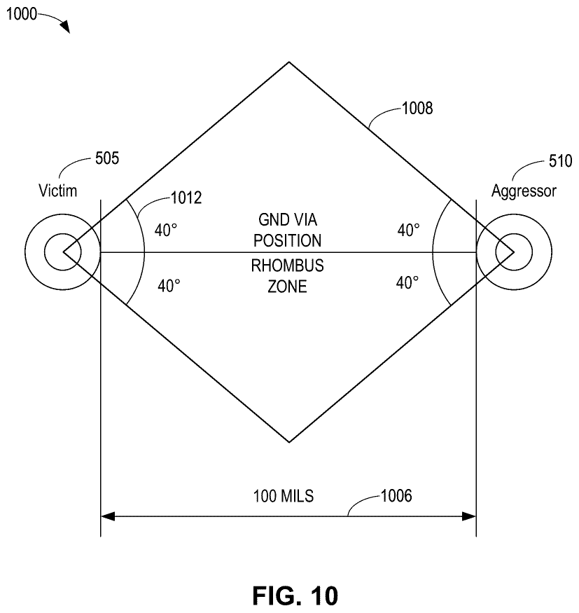

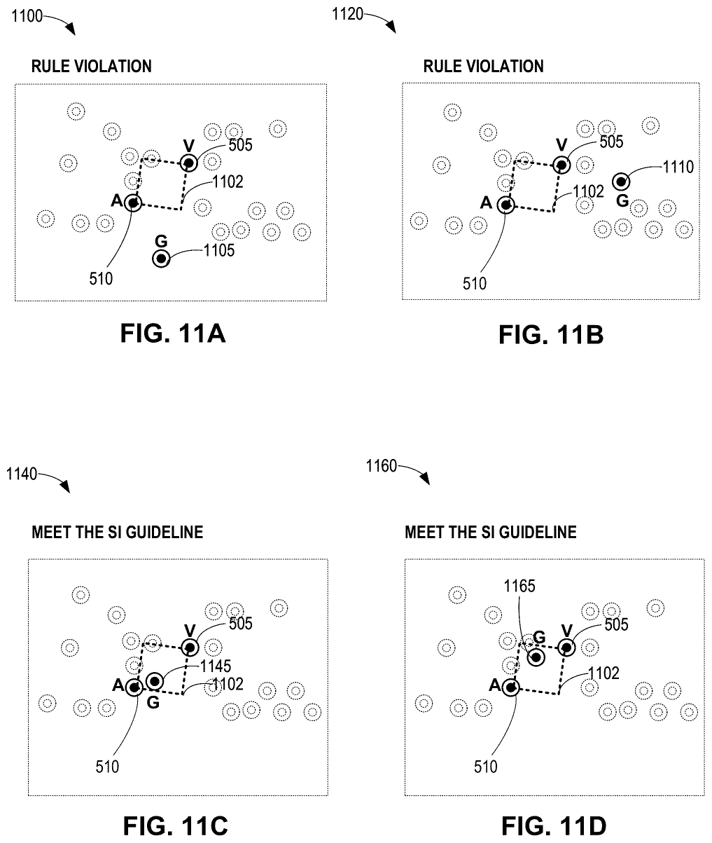

The classifier circuitry 135 classifies design regions into protective and non-protective areas based on layout features and allowed ground via placement area(s). For example, the classifier circuitry 135 identifies the protective and non-protective areas of a PCB layout based on allowed and disallowed area(s) for ground via placement identified using a crosstalk baseline, as shown in connection with FIGS. 9A-9B. For example, the protective area defines a zone within which the ground via is to be placed so that the crosstalk between the first and second signal vias satisfies a threshold (e.g., represented by the crosstalk baseline). In some examples, the classifier circuitry 135 outputs a visual representation (e.g., a rhombus-shaped area) identifying regions of the PCB layout where the ground via can be positioned relative to the victim and aggressor via(s) (e.g., protective areas), as shown in connection with FIG. 10. For example, the classifier circuitry 135 generates the visual representation of ground via placement based on parametric simulations and/or angle variation assessment(s) performed using the analyzer circuitry 130. In some examples, the classifier circuitry 135 determines whether a potential ground via placement meets positioning guidelines or violates the positioning guidelines associated with ground via placement relative to the aggressor and victim vias, as shown in connection with FIGS. 11A-11D. For example, while the analyzer circuitry 130 identifies the area(s) (e.g., rhombus-shaped area) of ground via placement on a given PCB-based layout using full-wave simulations and the Nyquist frequency, the classifier circuitry 135 generates the visual representation(s) associated with these assessments. In some examples, the classifier circuitry 135 is instantiated by programmable circuitry executing classifier instructions and/or configured to perform operations such as those represented by the flowchart(s) of FIGS. 2 and/or 4.

In some examples, the apparatus includes means for classifying. For example, the means for classifying may be implemented by the classifier circuitry 135. In some examples, the classifier circuitry 135 may be instantiated by programmable circuitry such as the example programmable circuitry 1212 of FIG. 12. For instance, the classifier circuitry 135 may be instantiated by the example microprocessor 1400 of FIG. 14 executing machine executable instructions such as those implemented by at least block 225 of FIG. 4. In some examples, the classifier circuitry 135 may be instantiated by hardware logic circuitry, which may be implemented by an ASIC, XPU, or the FPGA circuitry 1500 of FIG. 15 structured to perform operations corresponding to the machine readable instructions. Additionally or alternatively, the classifier circuitry 135 may be instantiated by any other combination of hardware, software, and/or firmware. For example, the classifier circuitry 135 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The data storage 140 can be used to store any information associated with the layout model trainer circuitry 110, via locator circuitry 115, crosstalk identifier circuitry 120, ground via placement identifier circuitry 125, analyzer circuitry 130, and/or classifier circuitry 135. The data storage 140 of the illustrated example of FIG. 1 can be implemented by any memory, storage device and/or storage disc for storing data such as flash memory, magnetic media, optical media, etc. Furthermore, the data stored in the data storage 140 can be in any data format such as binary data, comma delimited data, tab delimited data, structured query language (SQL) structures, image data, etc.

While an example manner of implementing the PCB layout optimizer circuitry 105 is illustrated in FIG. 1, one or more of the elements, processes and/or devices illustrated in FIG. 1 may be combined, divided, re-arranged, omitted, eliminated and/or implemented in any other way. Further, the example layout model trainer circuitry 110, example via locator circuitry 115, example crosstalk identifier circuitry 120, example ground via placement identifier circuitry 125, example analyzer circuitry 130, example classifier circuitry 135, and/or, more generally, the example PCB layout optimizer circuitry 105 of FIG. 1 may be implemented by hardware, software, firmware and/or any combination of hardware, software and/or firmware. Thus, for example, any of the example layout model trainer circuitry 110, example via locator circuitry 115, example crosstalk identifier circuitry 120, example ground via placement identifier circuitry 125, example analyzer circuitry 130, example classifier circuitry 135, and/or, more generally, the example PCB layout optimizer circuitry 105 of FIG. 1 could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s), ASIC(s)), programmable logic device(s) (PLD(s)), and/or field programmable logic device(s) (FPLD(s)) such as FPGAs. Further still, the PCB layout optimizer circuitry 105 of FIG. 1 may include one or more elements, processes, and/or devices in addition to, or instead of, those illustrated in FIG. 1, and/or may include more than one of any or all of the illustrated elements, processes and devices.

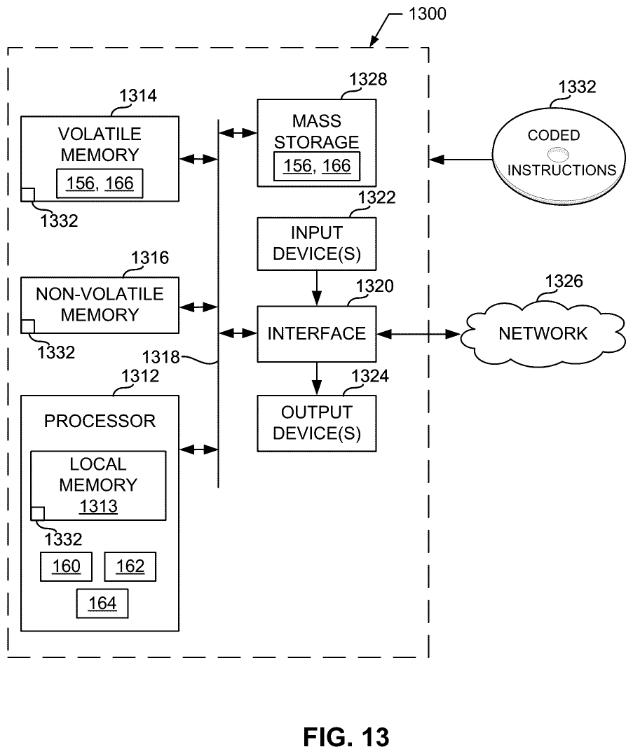

Flowcharts representative of example machine readable instructions, which may be executed by programmable circuitry to implement and/or instantiate the PCB layout optimizer circuitry 105 of FIG. 1 and/or representative of example operations which may be performed by programmable circuitry to implement and/or instantiate the PCB layout optimizer circuitry 105 of FIG. 1, are shown in FIGS. 2-4. The machine readable instructions may be one or more executable programs or portion(s) of one or more executable programs for execution by programmable circuitry, such as the programmable circuitry 1212, 1213 shown in the example processor platform 1200 discussed below in connection with FIGS. 12-13 and/or may be one or more function(s) or portion(s) of functions to be performed by the example programmable circuitry (e.g., an FPGA) discussed below in connection with FIGS. 14 and/or 15. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 2-4, many other methods of implementing the example PCB layout optimizer circuitry 105 of FIG. 1 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 2-4 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 2 is a flowchart representative of example machine readable instructions and/or example operations 200 that may be executed, instantiated, and/or performed by programmable circuitry to implement the example PCB layout optimizer circuitry 105 of FIG. 1. The machine-readable instructions and/or the operations 200 of FIG. 2 begin at block 205, at which the layout model trainer circuitry 110 determines whether an input PCB layout has been received (e.g., sample PCB layout input by a user to identify preferred ground via positioning). In the example of FIG. 2, the layout model trainer circuitry 110 identifies whether the layout model has been trained, at block 210. If the layout model requires training, the layout model trainer circuitry 110 proceeds to train the layout model, at block 215, as described in more detail in connection with FIG. 3. If the layout model has been trained to predict protective and non-protective area(s) based on PCB layout features, the ground via placement identifier circuitry 125 proceeds to determine allowed area(s) for ground via placement in the input PCB layout, at block 220, as described in connection with FIG. 4. Once the allowed area(s) for ground via placement are identified, the classifier circuitry 135 classifies design regions of the PCB into protective and non-protective areas based on layout features and allowed ground via placement area(s), at block 225. For example, the classifier circuitry 135 identifies areas of the PCB where the ground via can be positioned relative to the aggressor via and/or the victim via. In some examples, the classifier circuitry 135 identifies the protective and non-protective areas based on other layout features of the PCB. In some examples, the classifier circuitry 135 identifies routing or trace placement based on identified shielding area(s) of the PCB to improve space reduction, at block 230. For example, the input PCB layout can include trace routing, signal via locations, trace locations, component locations, and/or other design elements. The classifier circuitry 135 can output proposed adjustments to the design elements based on regions of the PCB layout designated as protective areas (e.g., areas suitable for ground via placement for shielding against crosstalk) and non-protective areas (e.g., areas not suitable for ground via placement). Based on these assessments, at block 235, the classifier circuitry 135 outputs an improved PCB board design that includes a low crosstalk environment based on identified positioning of the ground via(s).

FIG. 3 is a flowchart representative of example machine readable instructions and/or example operations 215 that may be executed, instantiated, and/or performed by programmable circuitry to implement the example PCB layout optimizer circuitry 105 of FIG. 1. The machine-readable instructions and/or the operations 215 of FIG. 2 begin at block 305, at which the layout model trainer circuitry 110 accesses training data 158 of FIG. 1. The training data 158 can include PCB layout(s) with various design elements that can be used to train the model to predict protective and non-protective area(s) based on the PCB layout features. In some examples, the training data is labeled. In some examples, the training data is sub-divided such that a portion of the data is used for validation purposes. The layout model trainer circuitry 110 identifies data features represented by the training data 158, at block 310. In some examples, the training controller 160 instructs the trainer 162 to perform training of the neural network using the training data 158 to generate a layout model 168, at block 315. In some examples, additional training is performed to refine the layout model 168, as determined at block 320.

FIG. 4 is a flowchart representative of example machine-readable instructions and/or example operations that may be executed, instantiated, and/or performed by example programmable circuitry to implement the example PCB layout optimizer circuitry 105 of FIG. 2 to determine allowed area(s) for ground via placement in the input PCB layout. The machine-readable instructions and/or the operations 220 of FIG. 4 begin at block 405, at which the crosstalk identifier circuitry 120 determines low crosstalk area(s) in the input PCB layout. In some examples, the crosstalk identifier circuitry 120 identifies crosstalk between a victim via and an aggressor via using a baseline, at block 410. For example, once the via locator circuitry 115 identifies the aggressor via and the victim via using the input PCB layout, the crosstalk identifier circuitry 120 identifies a baseline crosstalk value and compares the obtained crosstalk between the victim and aggressor via(s) using the baseline, as described in more detail in connection with FIGS. 8A, 8B, and 9B. The analyzer circuitry 130 proceeds to perform angle and distance iterations of ground via placement relative to the victim and aggressor via(s), at block 420, as shown in more detail in connection with FIGS. 7A and 7B. For example, the analyzer circuitry 130 performs parametric-based simulations with the ground via being systematically positioned between the victim via and the aggressor via, as described in connection with FIGS. 8A and 8B. In some examples, the ground via placement identifier circuitry 125 modifies the ground via path (e.g., including varying angle positions relative to the victim and aggressor vias) to allow for identification of the level of crosstalk based on the ground via positioning (e.g., near-end crosstalk, far-end crosstalk).

The analyzer circuitry 130 proceeds to identify a Nyquist frequency of interest, at block 425, and extracts crosstalk values (e.g., for near-end crosstalk and far-end crosstalk) at the identified frequency, at block 430. The analyzer circuitry 130 also determines a constraint value associated with the ground via placement and angle sweep, at block 435. For example, once the crosstalk is extracted, the analyzer circuitry 130 generates graphical representations that permit identification of the point at which the crosstalk with the ground via placement and the angle sweep has a value greater than and/or equal to a set crosstalk baseline (e.g., the constraint value). The analyzer circuitry 130 therefore identifies a maximum angle and maximum distance between the victim via and the aggressor via (e.g., where the ground via can be positioned) based on the constraint value, at block 440, as also described in more detail in connection with FIGS. 9A-9B. For example, the analyzer circuitry 130 identifies a radial placement of the ground via relative to the first signal via and the second signal via. Based on the identified maximum angle and distance for ground via placement, the crosstalk identifier circuitry 120 determines near-end crosstalk and far-end crosstalk values, at block 445. The analyzer circuitry 130 compares the crosstalk values from varying locations and/or angles associated with ground via placement to define an allowed and/or disallowed area where the ground via can be positioned in the input PCB layout, at block 450. As described in connection with FIG. 2, the classifier circuitry 135 classifies the input PCB layout into protective and non-protective areas based on the allowed ground via placement area(s) identified using the analyzer circuitry 130, as shown in more detail in connection with FIGS. 11A-11D.

FIG. 5 illustrates example structure 500 and example positioning 550 of a first signal via 505 (e.g., a victim via) relative to a second signal via 510 (e.g., an aggressor via). A via is a metallic lined hole connected to the metal circuitry of the PCB used for conducting an electrical signal between different layers of the board. The use of vias allows for shortening the distance needed for routing a trace to complete the connection. Via structures include through hole vias, blind vias, stacked vias, staggered vias, and microvias. The through hole via is drilled all the way through the PCB, while other vias may extend only partially through the board. While most circuit boards use a through hole via for signal routing, denser boards can also use blind vias and/or microvias. In the example of FIG. 5, the victim via 505 and the aggressor via 510 are through hole vias.

The via(s) allow signals and power to travel between the layers. For example, since circuits between layers of the multilayer PCB are independent of each other, a via provides an inter-layer connection. In some examples, crosstalk occurs between vias (e.g., resulting in unwanted coupling between aggressor signals and victim signals). Crosstalk sources can include connectors, cables, alternating circuit (AC) coupling capacitors, PCB traces, and/or other vias. For example, crosstalk can be defined as a function of the relative signal strength of the aggressor signal as compared to the victim signal at the region of coupling. As such, crosstalk occurs when energy in a first signal (e.g., aggressor signal) couples onto a second signal (e.g., victim signal), such that the first signal adversely affects the performance of the second signal. In some examples, channel crosstalk can be identified based on a signal to power sum crosstalk ratio (e.g., using Nyquist frequency).

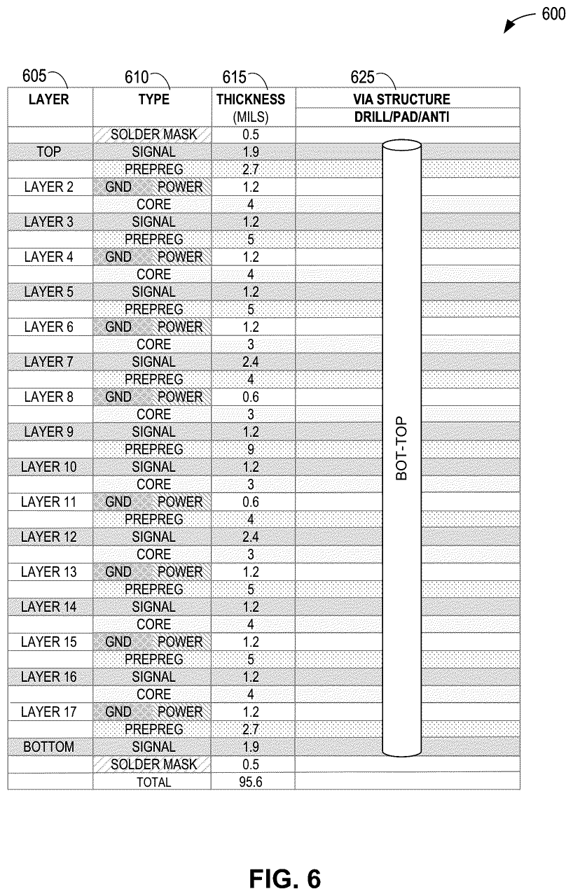

In the example of FIG. 5, crosstalk (e.g., near-end crosstalk (NEXT) and far-end crosstalk (FEXT)) is identified between the victim via 505 and the aggressor via 510 using an example distance 555 (e.g., maximum distance of 300 mils). For example, crosstalk is identified without the use of a ground via to establish a crosstalk baseline, as described in connection with FIG. 4. In examples disclosed herein, the victim via 505 and the aggressor via 510 are tested using a real-world PCB stack-up design for proof-of-concept purposes, as shown in connection with FIG. 6.

FIG. 6 illustrates an example printed circuit board (PCB) stack-up 600 used in three-dimensional simulation(s) disclosed herein. In the example of FIG. 6, the PCB stack-up 600 includes a PCB layer 605 (e.g., top layer, layer 1, etc.), a layer type 610 (e.g., solder mask layer, pre-impregnated (pre-preg) fibers layer, etc.), a layer thickness 615, and a via structure 625 (e.g., a pad, an anti-pad, etc.). In the example of FIG. 6, the via structure 625 is shown passing through all of the layers of the PCB stack-up 600 (e.g., as a through hole via). As such, the PCB stack-up 600 of FIG. 6 represents an example stack-up used for testing positioning of one or more via(s).

FIG. 7A illustrates example positioning 700 of a ground via relative to the first signal via (e.g., the victim via 505) and the second signal via (e.g., the aggressor via 510). In the example of FIG. 7A, the ground via is in a first position 705 (e.g., closer to the victim via 505) within an example first distance (x) 710 (e.g., 100 mils) that separates the victim via 505 from the aggressor via 510. In some examples, a parametric simulation (e.g., using electromagnetic simulation software such as Ansys HFSS, EMWorks, etc.) can be executed with the ground via being systematically placed between the victim via and the aggressor via at different positions (e.g., different points along the first distance 710). For example, the ground via can be in a second position 715 (e.g., closer to the aggressor via 510) within the first distance 710. As such, the ground via path is modified to allow for identification of the level of crosstalk based on the ground via positioning (e.g., near-end crosstalk (NEXT) and far-end crosstalk (FEXT)).

FIG. 7B illustrates example positioning 750 of a ground via at a specified angle relative to the victim via 505 and/or the aggressor via 510, which remain in a fixed position. For example, a second distance (y) 755 (e.g., 40 mils) different from the first distance (x) 710 can be identified for positioning the ground via (e.g., at a first position 760 directly between the victim via 505 and the aggressor via 510 or at a second position 765 that is located at an angle 770 from the victim via 505). For example, while placement of a ground via introduces shielding, how crosstalk tends to couple between two vias depends not only on the intermediate ground via but also on the angle at which the ground via is positioned. For example, traditional conservative spacing rules may not fully realize the potential benefits of ground vias acting as shielding, and reduced spacing requirements would represent a cost benefit in PCB designs. As such, identification of a low crosstalk environment is beneficial for overall PCB design quality.

FIG. 8A illustrates an example first curve corresponding to parametric variation(s) 800, 830 of ground via placement (e.g., without an angle sweep) for a through hole via. FIG. 8B illustrates an example second curve corresponding to parametric variation(s) 860, 890 of ground via placement (e.g., with an angle sweep) for a through hole via. In the example of FIGS. 8A-8B, the parametric variation(s) 800, 830 are plotted for crosstalk associated with near-end crosstalk (NEXT) 805 and far-end crosstalk (FEXT) 835 at a specified distance 810 position (in mils) and/or angle sweep 865 (in degrees) of the ground via, respectively. For example, the ground via position can be varied as shown in connection with FIGS. 7A-7B, where the placement of the ground via can range from (1) a first position 760 directly between the victim via 505 and the aggressor via 510 to (2) a second position 765 that is located at an angle 770 from the victim via 505 (e.g., position with angular sweep). In the example of FIG. 8A, a through hole via (THV) is used for parametric simulations since a THV is considered the worst case from a crosstalk perspective, given that a THV represents the longest via length. In the example of FIGS. 8A-8B, the curve(s) are fitted using a quadratic equation to show the symmetry of the effect, indicating that results for both FEXT and NEXT are similar.

Once the parametric simulations are completed, the analyzer circuitry 130 of FIG. 1 identifies a Nyquist frequency of interest and extracts the crosstalk (NEXT, FEXT) at that specific frequency. Once the crosstalk is extracted, the analyzer circuitry 130 plots and compares the curves with a set baseline. For example, when the analyzer circuitry 130 identifies the point at which the crosstalk with the ground (GND) via placement and the angle sweep has a value greater than and/or equal to the baseline, the analyzer circuitry 130 identifies that value as a constraint value, such that the constraint value is a maximum angle and maximum distance between the signal (e.g., victim via) and the aggressor via. Since the analyzer circuitry 130 obtains the crosstalk (NEXT, FEXT) values from varying locations and/or angles associated with ground (GND) via placement, the analyzer circuitry 130 can define an allowed and/or disallowed area where the ground via can be placed, as shown in connection with FIGS. 9A-9B.

FIG. 9A illustrates example angle variation 900 associated with ground via 902 placement and corresponding horizontal distance of the ground via 902 relative to the victim via 505. In the example of FIG. 9A, the ground via 902 is positioned at various angles relative to the victim via 505 (e.g., positions from 0 degrees to 60 degrees). For example, the ground via angle position(s) 904, 906, 908, 910, 912, 914, 916 are with respect to the victim via 505, with a fixed angle position 918 of 40 degrees relative to the aggressor via 510. In some examples, the ground via 902 can be located closer or farther away from the victim via 505 along the 0 degree angle 916 (e.g., at horizontal distances 920, 922, 924, 926 corresponding to 60.0 mils, 71.1 mils, 83.7 mils, and/or 99.2 mils). Example table 930 indicates the corresponding angles 932 and horizontal distances 934 associated with ground via 902 placement with respect to the victim via 505.

FIG. 9B illustrates example allowed and disallowed areas 950, 970 for ground via 902 placement relative to the victim via 505, as shown in connection with FIG. 9A. For example, the analyzer circuitry 130 identifies the crosstalk-related NEXT and FEXT values for the various locations and/or angles 952, 972 associated with the ground via 902 positioning. These crosstalk values indicate the allowed and disallowed areas for ground via placement based on an example horizontal spacing 954 (e.g., ground via 902 to victim via 505 horizontal spacing). For example, the allowed and disallowed areas are identified relative to a crosstalk baseline (e.g., crosstalk baseline of −24 dB at 3.2 GHz for Double Data Rate 5 (DDR5)). In the example of FIG. 9B, areas where the ground via 902 is not allowed are indicated using bolded NEXT and/or FEXT measurements. In some examples, the PCB layout optimizer circuitry 105 of FIG. 1 uses these measurements to define a closed form expression (e.g., in the shape of a rhombus) which determines where the ground via can be positioned with respect to the victim via 505 and/or the aggressor via 510.

FIG. 10 illustrates example positioning of a ground via between a victim via 505 and an aggressor via 510, with a rhombus representing an example zone 1000 for ground via positioning based on identified crosstalk (e.g., near-end crosstalk and/or far-end crosstalk). In the example of FIG. 10, the PCB layout optimizer circuitry 105 of FIG. 1 identifies a rhombus zone 1008 for positioning of the ground via, based on a 40-degree angle 1012 from the victim and/or aggressor vias 505, 510, as identified in connection with the parametric simulations and/or angle variation assessment(s) of FIGS. 8A, 8B, 9A, and/or 9B. In the example of FIG. 10, the victim via 505 is positioned at a horizontal distance 1006 of 100 mils from the aggressor via 510. In examples disclosed herein, identification of the layout area (e.g., rhombus) for ground via placement can be performed only once, such that there is no need to iterate through layout versions to guarantee full layout coverage of potential ground via positioning.

FIG. 11A illustrates a first example 1100 of a rule violation associated with ground via placement outside an example rhombus zone 1102. In the example of FIG. 11A, a first ground via placement 1105 is outside of the rhombus zone 1102, which is defined between the victim via 505 and the aggressor via 510. As such, first ground via placement 1105 violates rules associated with crosstalk reduction and/or signal integrity (SI). FIG. 11B illustrates a second example 1120 of a rule violation associated with second ground via placement 1110 outside the rhombus zone 1102. Conversely, FIGS. 11C and 11D illustrate a third example 1140 of a third ground via placement 1145 and a fourth example 1160 of a fourth ground via placement 1165 that satisfies SI-based guidelines based on positioning within the rhombus zone 1102, respectively. As such, a PCB layout check can be performed using the rhombus zone 1102 to reduce the occurrence of crosstalk, without the need to perform three-dimensional electromagnetic simulations. In examples disclosed herein, the distance between the two signal vias (e.g., victim via, aggressor via) is determined to identify an improved location for ground via placement. In examples disclosed herein, the rhombus zone 1102 is selected as the preferred shape for identifying a specific area of low crosstalk. As described herein, the rhombus is defined using full-wave simulations and the Nyquist frequency of Double Data Rate 5 (DDR5) (e.g., 3.2 GHZ), which represents one of the most critical single-ended signals in select central processing unit (CPU) designs. In examples disclosed herein, the rhombus zone 1102 obtained from the proposed methodology can be incorporated into artificial intelligence-based models to identify areas of reduced crosstalk for specific PCB-based input layouts. In examples disclosed herein, the rhombus zone indicates a protective area (e.g., area suitable for ground via placement for shielding against crosstalk). For example, areas outside of the rhombus zone (e.g., non-protective areas) result in crosstalk and are not suitable for ground via placement.

FIG. 12 is a block diagram of an example programmable circuitry platform 1200 structured to execute and/or instantiate the example machine-readable instructions and/or the example operations of FIGS. 2 and/or 4 to implement the example PCB layout optimizer circuitry 105 of FIG. 1. The programmable circuitry platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1200 of the illustrated example includes programmable circuitry 1212. The programmable circuitry 1212 of the illustrated example is hardware. For example, the programmable circuitry 1212 can be implemented by one or more integrated circuits, logic circuits, FPGAs microprocessors, CPUs, GPUs, DSPs, and/or microcontrollers from any desired family or manufacturer. The programmable circuitry 1212 may be implemented by one or more semiconductor based (e.g., silicon based) devices. In this example, the processor circuitry 1212 implements the layout model trainer circuitry 110, the via locator circuitry 115, the crosstalk identifier circuitry 120, the ground via placement identifier circuitry 125, the analyzer circuitry 130, and the classifier circuitry 135.

The programmable circuitry 1212 of the illustrated example includes a local memory 1213 (e.g., a cache, registers, etc.). The programmable circuitry 1212 of the illustrated example is in communication with a main memory including a volatile memory 1214 and a non-volatile memory 1216 by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217. In some examples, the memory controller 1217 may be implemented by one or more integrated circuits, logic circuits, microcontrollers from any desired family or manufacturer, or any other type of circuitry to manage the flow of data going to and from the main memory 1214, 1216.

The programmable circuitry platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user (e.g., a human user, a machine user, etc.) to enter data and/or commands into the programmable circuitry 1212. The input device(s) 1222 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1224 are also connected to the interface circuitry 1220 of the illustrated example. The output devices 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 1200 of the illustrated example also includes one or more mass storage devices 1228 to store software and/or data. Examples of such mass storage devices 1228 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 1232, which may be implemented by the machine readable instructions of FIGS. 3, 4, 6, and/or 7, may be stored in the mass storage device 1228, in the volatile memory 1214, in the non-volatile memory 1216, and/or on at least one non-transitory computer readable storage medium such as a CD or DVD which may be removable.

FIG. 13 is a block diagram of an example programmable circuitry platform 1300 structured to execute and/or instantiate the example machine-readable instructions and/or the example operations of FIG. 3 to implement the example computing system 150 of FIG. 1. The programmable circuitry platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1300 of the illustrated example includes programmable circuitry 1312. The programmable circuitry 1312 of the illustrated example is hardware. For example, the programmable circuitry 1312 can be implemented by one or more integrated circuits, logic circuits, FPGAs microprocessors, CPUs, GPUs, DSPs, and/or microcontrollers from any desired family or manufacturer. The programmable circuitry 1312 may be implemented by one or more semiconductor based (e.g., silicon based) devices. In this example, the programmable circuitry 1312 implements the example neural network processor 164, the example trainer 162, and the example training controller 160.

The programmable circuitry 1312 of the illustrated example includes a local memory 1313 (e.g., a cache, registers, etc.). The programmable circuitry 1312 of the illustrated example is in communication with a main memory including a volatile memory 1314 and a non-volatile memory 1316 by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and from the main memory 1314, 1316.

The programmable circuitry platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user (e.g., a human user, a machine user, etc.) to enter data and/or commands into the programmable circuitry 1312. The input device(s) 1322 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1324 are also connected to the interface circuitry 1320 of the illustrated example. The output devices 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 1300 of the illustrated example also includes one or more mass storage devices 1328 to store software and/or data. Examples of such mass storage devices 1328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 1332, which may be implemented by the machine readable instructions of FIG. 5, may be stored in the mass storage device 1328, in the volatile memory 1314, in the non-volatile memory 1316, and/or on at least one non-transitory computer readable storage medium such as a CD or DVD which may be removable.

FIG. 14 is a block diagram of an example implementation of the programmable circuitry 1212, 1312 of FIGS. 12 and 13. In this example, the programmable circuitry 1212, 1312 of FIGS. 12 and 13 is implemented by a microprocessor 1400. For example, the microprocessor 1400 may be a general purpose microprocessor (e.g., general purpose microprocessor circuitry). The microprocessor 1400 executes some or all of the machine readable instructions of the flowchart of FIGS. 2, 3, and/or 4 to effectively instantiate the circuitry of FIG. 1 logic circuits to perform the operations corresponding to those machine readable instructions. In some such examples, the circuitry of FIG. 1 is instantiated by the hardware circuits of the microprocessor 1400 in combination with the instructions. For example, the microprocessor 1400 may implement multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine readable instructions. For example, machine code corresponding to a firmware program, an embedded software program, or a software program may be executed by one of the cores 1402 or may be executed by multiple ones of the cores 1402 at the same or different times. In some examples, the machine code corresponding to the firmware program, the embedded software program, or the software program is split into threads and executed in parallel by two or more of the cores 1402. The software program may correspond to a portion or all of the machine readable instructions and/or operations represented by the flowcharts of FIGS. 2, 3, and/or 4.

The cores 1402 may communicate by a first example bus 1404. In some examples, the first bus 1404 may implement a communication bus to effectuate communication associated with one(s) of the cores 1402. For example, the first bus 1404 may implement at least one of an Inter-Integrated Circuit (I2C) bus, a Serial Peripheral Interface (SPI) bus, a PCI bus, or a PCIe bus. Additionally or alternatively, the first bus 1404 may implement any other type of computing or electrical bus. The cores 1402 may obtain data, instructions, and/or signals from one or more external devices by example interface circuitry 1406. The cores 1402 may output data, instructions, and/or signals to the one or more external devices by the interface circuitry 1406. Although the cores 1402 of this example include example local memory 1420 (e.g., Level 1 (L1) cache that may be split into an L1 data cache and an L1 instruction cache), the microprocessor 1400 also includes example shared memory 1410 that may be shared by the cores (e.g., Level 2 (L2_cache)) for high-speed access to data and/or instructions. Data and/or instructions may be transferred (e.g., shared) by writing to and/or reading from the shared memory 1410. The local memory 1420 of each of the cores 1402 and the shared memory 1410 may be part of a hierarchy of storage devices including multiple levels of cache memory and the main memory (e.g., the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1402 may be referred to as a CPU, DSP, GPU, etc., or any other type of hardware circuitry. Each core 1402 includes control unit circuitry 1414, arithmetic and logic (AL) circuitry (sometimes referred to as an ALU) 1416, a plurality of registers 1418, the L1 cache 1420, and a second example bus 1422. Other structures may be present. For example, each core 1402 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 1402. The AL circuitry 1416 includes semiconductor-based circuits structured to perform one or more mathematic and/or logic operations on the data within the corresponding core 1402. The AL circuitry 1416 of some examples performs integer-based operations. In other examples, the AL circuitry 1416 also performs floating-point operations. In yet other examples, the AL circuitry 1416 may include first AL circuitry that performs integer-based operations and second AL circuitry that performs floating point operations. In some examples, the AL circuitry 1416 may be referred to as an Arithmetic Logic Unit (ALU).

The registers 1418 are semiconductor-based structures to store data and/or instructions such as results of one or more of the operations performed by the AL circuitry 1416 of the corresponding core 1402. For example, the registers 1418 may include vector register(s), SIMD register(s), general purpose register(s), flag register(s), segment register(s), machine specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure including distributed throughout the core 1402 to shorten access time. The second bus 1422 may be implemented by at least one of an I2C bus, a SPI bus, a PCI bus, or a PCIe bus.

Each core 1402 and/or, more generally, the microprocessor 1400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (ICs) contained in one or more packages.

The microprocessor 1400 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1400, in the same chip package as the microprocessor 1400 and/or in one or more separate packages from the microprocessor 1400.

FIG. 15 is a block diagram of another example implementation of the programmable circuitry of FIGS. 12-13. In this example, the programmable circuitry 1212, 1312 is implemented by FPGA circuitry 1500. For example, the FPGA circuitry 1500 may be implemented by an FPGA. The FPGA circuitry 1500 can be used, for example, to perform operations that could otherwise be performed by the example microprocessor 1400 of FIG. 14 executing corresponding machine readable instructions. However, once configured, the FPGA circuitry 1500 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1400 of FIG. 14 described above (which is a general purpose device that may be programmed to execute some or all of the machine readable instructions represented by the flowcharts of FIGS. 2, 3, and/or 4 but whose interconnections and logic circuitry are fixed once fabricated), the FPGA circuitry 1500 of the example of FIG. 15 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 2, 3, and/or 4. In particular, the FPGA 1500 may be thought of as an array of logic gates, interconnections, and switches. The switches can be programmed to change how the logic gates are interconnected by the interconnections, effectively forming one or more dedicated logic circuits (unless and until the FPGA circuitry 1500 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 2, 3, and/or 4. As such, the FPGA circuitry 1500 may be configured and/or structured to effectively instantiate some or all of the operations/functions corresponding to the machine readable instructions of the flowcharts of FIGS. 2, 3, and/or 4 as dedicated logic circuits to perform the operations/functions corresponding to those software instructions in a dedicated manner analogous to an ASIC. Therefore, the FPGA circuitry 1500 may perform the operations/functions corresponding to the some or all of the machine readable instructions of FIGS. 2, 3, and/or 4 faster than the general-purpose microprocessor can execute the same.

In the example of FIG. 15, the FPGA circuitry 1500 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

The FPGA circuitry 1500 of FIG. 15, includes example input/output (I/O) circuitry 1502 to obtain and/or output data to/from example configuration circuitry 1504 and/or external hardware 1506. For example, the configuration circuitry 1504 may be implemented by interface circuitry that may obtain a binary file, which may be implemented by a bit stream, data, and/or machine-readable instructions, to configure the FPGA circuitry 1500, or portion(s) thereof. In some such examples, the configuration circuitry 1504 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1506 may be implemented by external hardware circuitry. For example, the external hardware 1506 may be implemented by the microprocessor 1400 of FIG. 14.

The FPGA circuitry 1500 also includes an array of example logic gate circuitry 1508, a plurality of example configurable interconnections 1510, and example storage circuitry 1512. The logic gate circuitry 1508 and the configurable interconnections 1510 are configurable to instantiate one or more operations/functions that may correspond to at least some of the machine readable instructions of FIGS. 2, 3, and/or 4 and/or other desired operations. The logic gate circuitry 1508 shown in FIG. 15 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations/functions. The logic gate circuitry 1508 may include other electrical structures such as look-up tables (LUTs), registers (e.g., flip-flops or latches), multiplexers, etc.

The configurable interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and increase execution speed.

The example FPGA circuitry 1500 of FIG. 15 also includes example dedicated operations circuitry 1514. In this example, the dedicated operations circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 14 and 15 illustrate two example implementations of the programmable circuitry 1212, 1312 of FIGS. 12-13, many other approaches are contemplated. For example, FPGA circuitry may include an on-board CPU, such as one or more of the example CPU 1520 of FIG. 15. Therefore, the programmable circuitry 1212, 1312 of FIGS. 12-13 may additionally be implemented by combining at least the example microprocessor 1400 of FIG. 14 and the example FPGA circuitry 1500 of FIG. 15. In some such hybrid examples, one or more cores 1502 of FIG. 15 may execute a first portion of the machine readable instructions represented by the flowchart(s) of FIGS. 2, 3, and/or 4 to perform first operation(s)/function(s), the FPGA circuitry 1500 of FIG. 15 may be configured and/or structured to perform second operation(s)/function(s) corresponding to a second portion of the machine readable instructions represented by the flowcharts of FIGS. 2, 3, and/or 4, and/or an ASIC may be configured and/or structured to perform third operation(s)/function(s) corresponding to a third portion of the machine readable instructions represented by the flowcharts of FIGS. 2, 3, and/or 4.

It should be understood that some or all of the circuitry of FIG. 2 may, thus, be instantiated at the same or different times. For example, same and/or different portion(s) of the microprocessor 1400 of FIG. 14 may be programmed to execute portion(s) of machine-readable instructions at the same and/or different times. In some examples, same and/or different portion(s) of the FPGA circuitry 1500 of FIG. 15 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1400 of FIG. 14 may execute machine readable instructions in one or more threads executing concurrently and/or in series. In some examples, the FPGA circuitry 1500 of FIG. 15 may be configured and/or structured to carry out operations/functions concurrently and/or in series. Moreover, in some examples, some or all of the circuitry of FIG. 2 may be implemented within one or more virtual machines and/or containers executing on the microprocessor 1400 of FIG. 14.

In some examples, the programmable circuitry 1212, 1312 of FIGS. 12-13 may be in one or more packages. For example, the microprocessor 1400 of FIG. 14 and/or the FPGA circuitry 1500 of FIG. 15 may be in one or more packages. In some examples, an XPU may be implemented by the programmable circuitry 1212, 1312 of FIGS. 12-13 which may be in one or more packages. For example, the XPU may include a CPU (e.g., the microprocessor 1400 of FIG. 14, the CPU 1520 of FIG. 15, etc.) in one package, a DSP (e.g., the DSP 1522 of FIG. 15) in another package, a GPU in yet another package, and an FPGA (e.g., the FPGA circuitry 1500 of FIG. 15) in still yet another package.

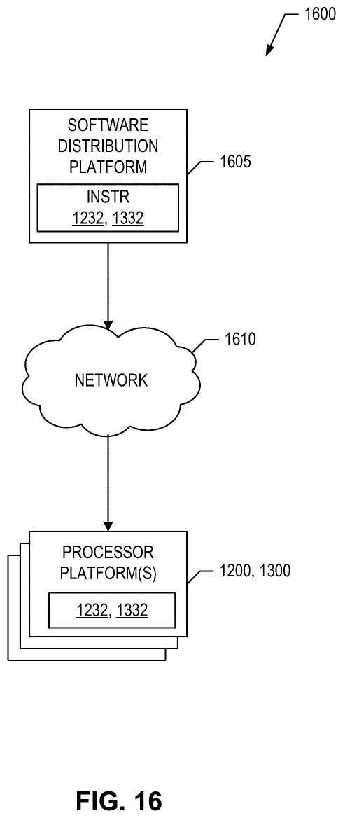

A block diagram illustrating an example software distribution platform 1605 to distribute software such as the example machine readable instructions 1232, 1332 of FIGS. 12-13 to other hardware devices (e.g., hardware devices owned and/or operated by third parties from the owner and/or operator of the software distribution platform) is illustrated in FIG. 16. The example software distribution platform 1605 may be implemented by any computer server, data facility, cloud service, etc., capable of storing and transmitting software to other computing devices. The third parties may be customers of the entity owning and/or operating the software distribution platform 1605. For example, the entity that owns and/or operates the software distribution platform 1605 may be a developer, a seller, and/or a licensor of software such as the example machine readable instructions 1232, 1332 of FIGS. 12-13. The third parties may be consumers, users, retailers, OEMs, etc., who purchase and/or license the software for use and/or re-sale and/or sub-licensing. In the illustrated example, the software distribution platform 1605 includes one or more servers and one or more storage devices. The storage devices store the machine readable instructions 1232, 1332, which may correspond to the example machine readable instructions of FIGS. 2, 3, and/or 4, as described above. The one or more servers of the example software distribution platform 1605 are in communication with an example network 1610, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1232, 1332 from the software distribution platform 1605. For example, the software, which may correspond to the example machine readable instructions of FIGS. 2, 3, and/or 4, may be downloaded to the example programmable circuitry platform 1200, which is to execute the machine readable instructions 1232 to implement the PCB layout optimizer circuitry 105 of FIG. 1. In some examples, one or more servers of the software distribution platform 1605 periodically offer, transmit, and/or force updates to the software (e.g., the example machine readable instructions 1232 of FIG. 12) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, methods, apparatus, and articles of manufacture disclosed herein enable a machine learning model to be applied to assess the PCB layout and provide flexibility to designers by identifying an area to position a shield via for low crosstalk (e.g., fit a rhombus-type shape to satisfy the solution space as compared to relying on restrictive line-of-sight (LOS) distance rules). In examples disclosed herein, designers are provided with a solution space instead of having to adhere to a specific distance between vias. For example, a trained machine learning model can be used to predict improved shielding areas in new PCB designs. In examples disclosed herein, placement for ground vias determined using the machine learning model results in a low crosstalk environment that ensures PCB design quality. For example, reducing the space between traces and vias reduce (e.g., minimizes) electromagnetic coupling, reducing crosstalk. Similarly, methods and apparatus disclosed herein can be used to avoid the expense of simulation tools and/or iteration of test builds during the PCB design cycle.

Example methods, apparatus, systems, and articles of manufacture for enabling unstructured sparsity in low-precision large pre-trained foundation models are disclosed herein. Further examples and combinations thereof include the following:

Example 1 includes an apparatus, comprising interface circuitry, machine-readable instructions, and at least one processor circuit to be programmed by the machine-readable instructions to identify crosstalk between a first signal via and a second signal via on a printed circuit board (PCB) layout, determine an area for placement of a ground via between the first signal via and the second signal via, and classify one or more regions of the PCB layout into at least one of a protective area or a non-protective area based on the area for placement of the ground via.

Example 2 includes the apparatus of example 1, wherein the protective area defines a zone within which the ground via is to be placed so that the crosstalk between the first signal via and the second signal via satisfies a threshold.

Example 3 includes the apparatus of any one of examples 1 or 2, wherein the zone has a rhombus shape.

Example 4 includes the apparatus of any one of examples 1-3, wherein one or more of the at least one processor circuit is to generate training data to train a layout model to classify the one or more regions of the PCB layout.

Example 5 includes the apparatus of any one of examples 1-4, wherein one or more of the at least one processor circuit is to identify a radial placement of the ground via relative to the first signal via and the second signal via.

Example 6 includes the apparatus of any one of examples 1-5, wherein one or more of the at least one processor circuit is to determine the area for placement of the ground via based on at least one of a full-wave simulation or a Nyquist frequency.

Example 7 includes the apparatus of example 6, wherein one or more of the at least one processor circuit is to determine at least one of a near-end crosstalk or a far-end crosstalk based on the Nyquist frequency.

Example 8 includes the apparatus of any one of examples 1-7, wherein one or more of the at least one processor circuit is to determine a constraint value associated with at least one of (i) placement of the ground via or (ii) an angle sweep of the ground via relative to at least one of the first signal via or the second signal via.

Example 9 includes a method comprising identifying crosstalk between a first signal via and a second signal via on a printed circuit board (PCB) layout, determining, by at least one processor circuit programmed by at least one instruction, an area for placement of a ground via between the first signal via and the second signal via, and classifying, by one or more of the at least one processor circuit, one or more regions of the PCB layout into at least one of a protective area or a non-protective area based on the area for placement of the ground via.

Example 10 includes the method of example 9, wherein the protective area defines a zone within which the ground via is to be placed so that the crosstalk between the first signal via and the second signal via satisfies a threshold.

Example 11 includes the method of any one of examples 9-10, including generating training data to train a layout model to classify the one or more regions of the PCB layout.

Example 12 includes the method of any one of examples 9-11, including identifying a radial placement of the ground via relative to the first signal via and the second signal via.

Example 13 includes the method of any one of examples 9-13, including determining the area for placement of the ground via based on at least one of a full-wave simulation or a Nyquist frequency.

Example 14 includes the method of example 13, including determining at least one of a near-end crosstalk or a far-end crosstalk based on the Nyquist frequency.

Example 15 includes at least one non-transitory machine-readable medium comprising machine-readable instructions to cause at least one processor circuit to at least identify crosstalk between a first signal via and a second signal via on a printed circuit board (PCB) layout, determine an area for placement of a ground via between the first signal via and the second signal via, and classify one or more regions of the PCB layout into at least one of a protective area or a non-protective area based on the area for placement of the ground via.

Example 16 includes the at least one non-transitory machine-readable medium of example 15, wherein the protective area defines a zone within which the ground via is to be placed so that the crosstalk between the first signal via and the second signal via satisfies a threshold.

Example 17 includes the at least one non-transitory machine-readable medium of any one of examples 15-17, wherein the machine-readable instructions are to cause one or more of the at least one processor circuit to generate training data to train a layout model to classify the one or more regions of the PCB layout.

Example 18 includes the at least one non-transitory machine-readable medium of any one of examples 15-18, wherein the machine-readable instructions are to cause one or more of the at least one processor circuit to identify a radial placement of the ground via relative to the first signal via and the second signal via.

Example 19 includes the at least one non-transitory machine-readable medium of any one of examples 15-19, wherein the machine-readable instructions are to cause one or more of the at least one processor circuit to determine the area for placement of the ground via based on at least one of a full-wave simulation or a Nyquist frequency.

Example 20 includes the at least one non-transitory machine-readable medium of example 19, wherein the machine-readable instructions are to cause one or more of the at least one processor circuit to determine at least one of a near-end crosstalk or a far-end crosstalk based on the Nyquist frequency.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus, comprising:
interface circuitry;
machine-readable instructions; and
at least one processor circuit to be programmed by the machine-readable instructions to:
identify crosstalk between a first signal via and a second signal via on a printed circuit board (PCB) layout;
determine an area for placement of a ground via between the first signal via and the second signal via; and
classify one or more regions of the PCB layout into at least one of a protective area or a non-protective area based on the area for placement of the ground via.

2. The apparatus of claim 1, wherein the protective area defines a zone within which the ground via is to be placed so that the crosstalk between the first signal via and the second signal via satisfies a threshold.

3. The apparatus of claim 2, wherein the zone has a rhombus shape.

4. The apparatus of claim 1, wherein one or more of the at least one processor circuit is to generate training data to train a layout model to classify the one or more regions of the PCB layout.

5. The apparatus of claim 1, wherein one or more of the at least one processor circuit is to identify a radial placement of the ground via relative to the first signal via and the second signal via.

6. The apparatus of claim 1, wherein one or more of the at least one processor circuit is to determine the area for placement of the ground via based on at least one of a full-wave simulation or a Nyquist frequency.

7. The apparatus of claim 6, wherein one or more of the at least one processor circuit is to determine at least one of a near-end crosstalk or a far-end crosstalk based on the Nyquist frequency.

8. The apparatus of claim 1, wherein one or more of the at least one processor circuit is to determine a constraint value associated with at least one of (i) placement of the ground via or (ii) an angle sweep of the ground via relative to at least one of the first signal via or the second signal via.

9. A method comprising:
identifying crosstalk between a first signal via and a second signal via on a printed circuit board (PCB) layout;
determining, by at least one processor circuit programmed by at least one instruction, an area for placement of a ground via between the first signal via and the second signal via; and
classifying, by one or more of the at least one processor circuit, one or more regions of the PCB layout into at least one of a protective area or a non-protective area based on the area for placement of the ground via.

10. The method of claim 9, wherein the protective area defines a zone within which the ground via is to be placed so that the crosstalk between the first signal via and the second signal via satisfies a threshold.

11. The method of claim 9, including generating training data to train a layout model to classify the one or more regions of the PCB layout.

12. The method of claim 9, including identifying a radial placement of the ground via relative to the first signal via and the second signal via.

13. The method of claim 9, including determining the area for placement of the ground via based on at least one of a full-wave simulation or a Nyquist frequency.

14. The method of claim 13, including determining at least one of a near-end crosstalk or a far-end crosstalk based on the Nyquist frequency.

15. At least one non-transitory machine-readable medium comprising machine-readable instructions to cause at least one processor circuit to at least:
identify crosstalk between a first signal via and a second signal via on a printed circuit board (PCB) layout;
determine an area for placement of a ground via between the first signal via and the second signal via; and
classify one or more regions of the PCB layout into at least one of a protective area or a non-protective area based on the area for placement of the ground via.

16. The at least one non-transitory machine-readable medium of claim 15, wherein the protective area defines a zone within which the ground via is to be placed so that the crosstalk between the first signal via and the second signal via satisfies a threshold.

17. The at least one non-transitory machine-readable medium of claim 15, wherein the machine-readable instructions are to cause one or more of the at least one processor circuit to generate training data to train a layout model to classify the one or more regions of the PCB layout.

18. The at least one non-transitory machine-readable medium of claim 15, wherein the machine-readable instructions are to cause one or more of the at least one processor circuit to identify a radial placement of the ground via relative to the first signal via and the second signal via.

19. The at least one non-transitory machine-readable medium of claim 15, wherein the machine-readable instructions are to cause one or more of the at least one processor circuit to determine the area for placement of the ground via based on at least one of a full-wave simulation or a Nyquist frequency.

20. The at least one non-transitory machine-readable medium of claim 19, wherein the machine-readable instructions are to cause one or more of the at least one processor circuit to determine at least one of a near-end crosstalk or a far-end crosstalk based on the Nyquist frequency.
